(19) United States
(12) Patent Application Publication
(10) Pub. No.: US 2012/0201930 A1
(43) Pub. Date: Aug. 9, 2012

(54) BREWABLE COFFEE PRODUCT CONTAINING SOLUBLE FIBER

(75) Inventor: Edwin Henry Fisher, III, West Hartford, CT (US)

(73) Assignee: GREEN LEAF FOODS, LLC, Glastonbury, CT (US)

(21) Appl. No.: 13/362,101

(22) Filed: Jan. 31, 2012

Related U.S. Application Data
(60) Provisional application No. 61/439,078, filed on Feb. 3, 2011.

(51) Int. Cl. A23F 5/00; A23L 1/308

(52) U.S. Cl. 426/71; 426/595

(57) ABSTRACT

A brewable coffee product that, when brewed, produces a coffee beverage having an increased amount of dietary fiber as compared to a coffee beverage brewed from traditional ground coffee. The brewable coffee product includes ground coffee beans and at least one plant-derived soluble fiber ingredient.

### CROSS-REFERENCE TO RELATED APPLICATIONS

This application claims priority to provisional U.S. Patent Application No. 61/439,078 filed on Feb. 3, 2011, the entirety of which is incorporated by reference herein.

### FIELD OF THE INVENTION

This invention relates to a brewable coffee product. More particularly, this invention relates to a brewable coffee product that, when brewed, produces a fiber-enhanced coffee beverage.

### BACKGROUND

Coffee beverages have been prepared and consumed since at least the 13^{th} century. Many individuals are coffee-drinkers and consume at least one coffee beverage on a daily basis. Coffee beverages include, but are not limited to, hot or chilled brewed coffee, lattes, cappuccinos, espresso, and the like.

Many individuals who consume coffee beverages on a daily basis fail to ingest the recommended daily amounts of certain nutrients. Examples of nutrients that individuals typically fall short in consuming are dietary fiber, and more particularly, prebiotic fiber products (“prebiotics”).

Dietary fiber, which includes both insoluble fiber and soluble fiber, is found naturally in plants that are consumed by individuals. Dietary fiber is the part of the plant that passes through an individual's digestive system undigested. Both soluble and insoluble fiber are important for digestion and may help prevent certain conditions such as heart disease, diabetes, obesity, diverticulitis, and constipation. Many health experts advise individuals to consume about 30 to 38 grams of dietary fiber a day, however, the average consumer only ingests about 10 to 12 grams of dietary fiber a day.

Prebiotics are ingredients present in fruits and vegetables that maintain and promote growth of beneficial bacteria that reside in a human's digestive system. Prebiotics are a soluble fiber and include, for example, inulin, oligofructose, fructooligosaccharides, galactooligosaccharides and other oligosaccharides. While prebiotics have been known and studied since at least the 1990's, information concerning recommend daily amounts of prebiotics have not be issued.

Since the average consumer has a deficiency in dietary fiber, it is a goal to increase the amount of dietary fiber ingested by a consumer in order to promote and maintain health in the consumer. Many consumers seeking to increase their dietary fiber intake have resorted to taking fiber supplements in the form of a drink, a tablet, a capsule, or the like. Such products may be expensive and/or ill-tasting. Additionally, consumers taking these supplements may feel that it is an extra step, or a “chore”, to consume the supplement on a daily basis. These problems, whether perceived or actual, may result in the consumer no longer using the supplements and thereby no longer ingesting appropriate or recommended amounts of dietary fiber. The product described herein is seen as a solution to this problem.

### SUMMARY

One aspect described herein is directed to a brewable coffee product comprising: ground coffee beans; and at least one plant-derived soluble fiber ingredient.

Another aspect described herein is directed to a method for increasing an amount of dietary fiber in a serving of a coffee beverage brewed from a brewable coffee product, the method comprising: combining at least one plant-derived soluble fiber ingredient with ground coffee beans, thereby forming a brewable coffee product; brewing the brewable coffee product to obtain a coffee beverage having at least 2.9 grams of dietary fiber per serving of the coffee beverage.

A further aspect described herein is directed to a coffee beverage brewed from the brewable coffee product described above.

These and other embodiments are described in greater detail below.

### DETAILED DESCRIPTION

The following description illustrates preferred embodiments of the subject matter disclosed herein. Those of skill in the art will recognize that there are numerous variations and modifications of this invention that are encompassed by its scope. Accordingly, the description of preferred embodiments should not be deemed to limit the scope of the present invention.

One aspect of the invention is a brewable coffee product that, when brewed, produces a coffee beverage having an increased amount of dietary fiber as compared to a coffee beverage brewed from ground coffee beans. By “brewable” it is meant that the coffee product can be brewed in traditional coffee makers, such as, for example, standard drip coffee makers, French presses, percolators, and the like. Additionally, the brewable coffee product can be placed in prepackaged containers or reusable containers that are employed in single cup coffee brewers, such as, for example, a Keurig® coffee brewer. It is contemplated that the brewable coffee product may be brewed in a manner similar to standard coffee products, i.e., by contacting the brewable coffee product with heated water, e.g., water having a temperature between about 190 degrees and 200 degrees Fahrenheit (190°-200° F.).

In one embodiment, the brewable coffee product includes ground coffee beans and at least one plant-derived soluble fiber ingredient. The brewable coffee product is typically a homogeneous mixture having a color, texture and aroma that is similar to traditional ground coffee beans. The at least one plant-derived soluble fiber ingredient renders the brewable coffee product a prebiotic.

The ground coffee beans used in the brewable coffee product can be any variety or type of coffee beans that have been roasted and ground for use in the brewing of coffee beverages. It is contemplated that the brewable coffee product can include light roasted ground coffee beans, dark roasted ground coffee beans, decaffeinated ground coffee beans, caffeinated ground coffee beans, or any variety of ground coffee beans that are desired or available to the user.

The coffee beans can be roasted by any process or manner that is known to roast coffee beans. In one example of the brewable coffee product, freshly dry roasted coffee beans are used. It is contemplated that the ground coffee beans can be of any quality, such as, for example, “regular” quality or “premium” quality.

The at least one plant-derived soluble fiber ingredient present in the brewable coffee product may be any soluble fiber product that is derived from a plant or a plant source, such as, for example, a vegetable, a fruit, or a root of a vegetable or fruit. In order to impart an increased amount of dietary fiber in the coffee beverage brewed from the brewable coffee product, the plant derived soluble fiber ingredient should be able to travel through a standard, commercially available coffee filter while withstanding the high temperatures of the water used to brew coffee. In a preferred embodiment, the at least one plant-derived soluble fiber ingredient should be similar in color to the ground coffee beans, or should be able to absorb the color of the ground coffee beans in order to produce a brewable coffee product that has the look, feel, and aroma of ground coffee.

In one embodiment of the brewable coffee product, the at least one plant-derived soluble fiber ingredient is inulin. The inulin utilized in the brewable coffee product may be derived from one or more plants and may be used in a powder form. For example, the inulin may be derived from jicama, agave, dandelion, wild yam, root of endive, Jerusalem artichoke, or a combination thereof. While inulin is typically white in color, it has been surprisingly found that when combined with ground coffee beans, the inulin can absorb some of the moisture from the ground coffee beans, which then imparts a coffee-like color to the inulin.

In another embodiment of the brewable coffee product, the at least one plant-derived soluble fiber ingredient may be ground and roasted root of endive, which is also known as chicory (herein referred to as “root of endive”). The root of endive typically has a color and consistency that is similar to ground coffee beans.

The brewable coffee product may also include a combination of inulin and root of endive. It has been surprisingly found that the inulin imparts an increased amount of dietary fiber to a coffee beverage brewed from brewable coffee product containing inulin, and that the addition of the root of endive imparts an additional amount of dietary fiber and also enhances the taste of the coffee beverage.

In one embodiment, the brewable coffee product includes from about 65 wt % to about 90 wt % of the ground coffee beans, and from about 10 wt % to about 35 wt % of the at least one plant-derived soluble fiber ingredient, based on the total weight of the brewable coffee product. It is contemplated that additional ingredients may be added to the brewable coffee product, including, but not limited to, flavor additives.

It is contemplated that the brewable coffee product includes ground coffee beans, inulin and root of endive. In such an embodiment, the brewed coffee product includes from about 5 wt % to about 15 wt % root of endive, from about 5 wt % to about 20 wt % inulin; and from about 65 wt % to about 90 wt % ground coffee beans, based on the total weight of the brewable coffee product.

In another embodiment, the brewable coffee product includes from about 5 wt % to about 12 wt % root of endive, from about 10 wt % to about 15 wt % of inulin, and from about 73 wt % to about 85 wt % of ground coffee beans, based on the total weight of the brewable coffee product. In a further embodiment, the brewable coffee product includes from about 9 wt % to about 10 wt % of the root of endive, from about 13wt % to about 14 wt % of the inulin, and from about 76 wt % to about 78 wt % of ground coffee beans, where the weight percents are based on the total weight of the brewable coffee product.

The contents of the brewable coffee product, i.e., the ground coffee beans and the at least one plant-derived soluble fiber ingredient, can be combined in any manner and method known in the art. For example, the ground coffee beans can be added to the at least one plant-derived soluble fiber ingredient, or the at least one plant-derived soluble fiber ingredient can be added to the ground coffee beans. After combining the contents of the brewable coffee product, the contents should be mixed in order to form a homogeneous mixture that has the look, texture and aroma of traditional ground coffee beans.

Combination of the ground coffee beans with the at least one plant-derived soluble fiber ingredient forms a brewable coffee product that has substantially uniform color and a substantially uniform moisture content. The uniform color lends itself to a more marketable product, while the uniform moisture content enhances the texture of the brewable coffee product as well as the taste of the coffee beverage brewed from the coffee product.

To obtain a coffee beverage having an increased amount of dietary fiber, a consumer places the brewable coffee product into a coffee maker of his choosing, and utilizes heated water to brew the coffee beverage. While a coffee beverage brewed from standard ground coffee beans has less than one gram of dietary fiber per serving, a coffee beverage brewed from the brewable coffee product described herein has a dietary fiber content of at least 2.9 grams per serving, the serving being 12 ounces (12 oz.) of the coffee beverage. In one embodiment, a coffee beverage brewed from the currently described brewable coffee product has a dietary fiber content of at least 3.4 grams per serving, the serving being 12 ounces (12 oz.) of the coffee beverage.

In another embodiment, the coffee beverage brewed from the currently described brewable coffee product has a dietary fiber content of at least 3.5 grams per serving, the serving being 12 ounces (12 oz.) of the coffee beverage. In yet a further embodiment, the coffee beverage brewed from the brewable coffee product has a dietary fiber content of at least 4.0 grams per serving, the serving being 12 ounces (12 oz.) of the coffee beverage.

The increase in dietary fiber present in the coffee beverage brewed from the currently described brewable coffee product will allow some consumers to more easily obtain the goal of consuming the recommended daily amount of 30 to 38 grams of dietary fiber without having to eat any additional products or consume any additional supplements.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A brewable coffee product comprising:
ground coffee beans; and
at least one plant-derived soluble fiber ingredient.

2. A brewable coffee product according to claim 1, comprising:
from about 65 wt % to about 90 wt % of the ground coffee beans, based on a total weight of the brewable coffee product; and
from about 10 wt % to about 35 wt % of the at least one plant-derived soluble fiber ingredient, based on the total weight of the brewable coffee product.

3. A brewable coffee product according to claim 1, wherein the brewable coffee product delivers at least 2.9 grams of dietary fiber per serving of a coffee beverage brewed from the brewable coffee product.

4. A brewable coffee product according to claim 3, wherein the serving of the coffee beverage is 12 ounces.

5. A brewable coffee product according to claim 3, wherein the brewable coffee product delivers at least 4.0 grams of dietary fiber per serving of a coffee beverage brewed from the brewable coffee product.

6. A brewable coffee product according to claim 5, wherein the serving of the coffee beverage is 12 ounces.

7. A brewable coffee product according to claim 1, wherein the brewable coffee product is a prebiotic.

8. A brewable coffee product according to claim 1, wherein the at least one plant-derived soluble fiber ingredient is selected from the group consisting of inulin, root of endive, and a combination thereof.

9. A brewable coffee product according to claim 8, wherein the at least one plant-derived soluble fiber ingredient comprises inulin and root of endive.

10. A brewable coffee product according to claim 9 comprising:
from about 5 wt % to about 15 wt % root of endive, based on a total weight of the brewable coffee product;
from about 5 wt % to about 20 wt % inulin, based on the total weight of the brewable coffee product; and
from about 65 wt % to about 90 wt % ground coffee beans, based on the total weight of the brewable coffee product.

11. A brewable coffee product according to claim 9, comprising:
from about 5 wt % to about 12 wt % root of endive, based on a total weight of the brewable coffee product;
from about 10 wt % to about 15 wt % of inulin, based on the total weight of the brewable coffee product; and
from about 73 wt % to about 85 wt % of ground coffee beans, based on the total weight of the brewable coffee product.

12. A brewable coffee product according to claim 8, wherein the inulin is derived from jicama, agave, dandelion, wild yam, root of endive, Jerusalem artichoke, or a combination thereof.

13. A method for increasing an amount of dietary fiber in a serving of a coffee beverage brewed from a brewable coffee product, the method comprising:
combining at least one plant-derived soluble fiber ingredient with ground coffee beans, thereby forming a brewable coffee product;
brewing the brewable coffee product to obtain a coffee beverage having at least 2.9 grams of dietary fiber per serving of the coffee beverage.

14. A method according to claim 13, wherein the brewable coffee product is a prebiotic.

15. A method according to claim 13, wherein the serving of the coffee beverage is 12 ounces.

16. A method according to claim 13, wherein the dietary fiber of the coffee beverage is 4.0 grams per serving of the coffee beverage.

17. A method according to claim 16, wherein the serving of the coffee beverage is 12 ounces.

18. A method according to claim 13, wherein the at least one plant-derived soluble fiber ingredient is selected from the group consisting of inulin, root of endive, and a combination thereof.

19. A method according to claim 18, wherein the brewable coffee product comprises:
from about 5 wt % to about 15 wt % root of endive, based on a total weight of the brewable coffee product;
from about 5 wt % to about 20 wt % inulin, based on the total weight of the brewable coffee product; and
from about 65 wt % to about 90 wt % ground coffee beans, based on the total weight of the brewable coffee product.

20. A coffee beverage brewed from the brewable coffee product according to claim 1.
